(19) United States
(12) Patent Application Publication
(10) Pub. No.: US 2024/0103796 A1
(43) Pub. Date: Mar. 28, 2024

(54) METHOD AND AUDIO MIXING INTERFACE PROVIDING DEVICE USING A PLURALITY OF AUDIO STEMS

(71) Applicant: Neutune Co.,Ltd., Seoul (KR)

(72) Inventors: Jong-Pil LEE, Seoul (KR); Sang-Eun KUM, Seoul (KR); Tae-Hyoung KIM, Seoul (KR); Keun-Hyoung KIM, Seoul (KR)

(73) Assignee: Neutune Co.,Ltd., Seoul (KR)

(21) Appl. No.: 18/470,736

(22) Filed: Sep. 20, 2023

(30) Foreign Application Priority Data
Sep. 22, 2022 (KR) 10-2022-0120327

(51) Int. Cl. G06F 3/16; G06F 3/04817; G06F 3/0482; G11B 27/031

(52) U.S. Cl. CPC G06F 3/162; G06F 3/04817; G06F 3/0482; G11B 27/031; H04H 60/04

(57) ABSTRACT

[SUMMARY]

A method of providing an audio mixing interface using multiple audio stems according to embodiment may comprise an audio mixing screen display step which displays an audio mixing screen including an audio block screen indicating audio blocks corresponding to at least one stem item preset for at least one audio version pre-stored for the audio on the display of a user device by the processor, when audio to be mixed is executed by the user, an audio block selection step which displays a selection block on a display of the user device in a shade different from that of the audio blocks by the processor, when the selection block selected by the user exists among the audio blocks displayed on the audio mixing screen and an audio session generation step which combines the audio information included in the selection block and create one session audio, when the user's selection of the audio block is completed.

### CROSS REFERENCE TO RELATED APPLICATIONS

The application claims priority based on Korean Patent Application No. 10-2022-0120327 filed Sep. 22, 2022, the entire disclosure of which is incorporated herein by reference.

### TECHNICAL FIELD

The present invention relates to a method and audio mixing interface providing device using a plurality of audio stems. More specifically, the present invention relates to a technology that provides an audio mixing interface that can freely mix audio according to the user's preference using various versions of the same audio and a plurality of stem data contained in each audio.

### BACKGROUND ART

Nowadays, users can store various types of media in portable user terminal devices and easily select and enjoy media they want while on the go.

In addition, media digitized through digital compression technology is explosively revitalizing online media services by enabling media sharing between users on a network, and many applications or programs related to this are being developed.

Among the vast amounts of media provided, music accounts for a significant portion. Compared to other types of media, it has a lower capacity and communication load, so it is easy to support real-time streaming services, resulting in high satisfaction for both service providers and users.

Accordingly, services that provide online music to users in various ways are currently emerging.

Existing online music services simply provide music in real time to users connected online, such as by providing music to the user's terminal device or providing streaming services.

However, recently, services are being provided that recommend highly preferred media to users by utilizing big data or artificial intelligence technology.

However, the current recommendation method in online music services is to simply count the number of music sources purchased, listened to, or searched by the user to create a music chart and make recommendations based on this.

This recommendation method recommends music based on statistical criteria based on the simple number of accesses and ignores the diversity and volatility of user preferences.

In addition, since this recommendation method recommends music based on the accumulated number of accesses, the volatility of the music chart is low, and most of the previously recommended music overlaps with the currently recommended music, greatly reducing its effectiveness.

Additionally, even if it is the same music, there are cases where users want to listen to various versions depending on their preferences.

However, currently, unless the music distribution company distributes the sound source in a different version, users are unable to listen to a version of the music with a different feel.

### PRIOR ART DOCUMENT

(PATENT DOCUMENT 1) Korean Patent Publication No. 10-2015-0084333 (published on Jul. 22, 2015)—‘Pitch recognition using sound interference phenomenon and scale notation method using the same’
(PATENT DOCUMENT 2) Korean Patent No. 10-1696555 (2019 Jun. 5)—‘Text location search system and method through voice recognition in image or geographic information’

### DISCLOSURE

### Technical Problem

Accordingly, the method and audio mixing interface providing device using a plurality of audio stems according to an embodiment are inventions designed to solve the problems described above.

Specifically, the purpose of the present invention is to provide a method and device that allows users to freely mix audio according to their taste.

More specifically, there is a purpose that the present invention seeks to provide an audio mixing interface that can freely mix audio according to the user's preference using various versions of audio data for the same audio and a plurality of stem data contained in each audio.

### Technical Solution

A method of providing an audio mixing interface using multiple audio stems according to embodiment may comprise an audio mixing screen display step which displays an audio mixing screen including an audio block screen indicating audio blocks corresponding to at least one stem item preset for at least one audio version pre-stored for the audio on the display of a user device by the processor, when audio to be mixed is executed by the user, an audio block selection step which displays a selection block on a display of the user device in a shade different from that of the audio blocks by the processor, when the selection block selected by the user exists among the audio blocks displayed on the audio mixing screen and an audio session generation step which combines the audio information included in the selection block and create one session audio, when the user's selection of the audio block is completed.

The stem item includes at least one of the audio's Rhythm stem, Bass stem, Mid stem, High stem, FX stem, and Melody stem.

The audio mixing screen display step further comprises a step, if there is a selection block selected by the user among the audio blocks, generating audio information corresponding to the selection block as waveform information and then displaying the waveform information on the audio mixing screen.

The audio mixing screen display step further includes a session block screen display step which divides the audio into a plurality of sessions over time according to a preset standard and then displays a session block screen including a plurality of session blocks corresponding to the plurality of sessions on the audio mixing screen.

The method of providing an audio mixing interface using multiple audio stems according to embodiment further comprises a mixing screen change step, when the user selects a session block other than the currently selected session block among the plurality of session blocks, which newly displays an audio block screen corresponding to the other selected session block on the audio mixing screen.

The session block screen display step further includes a step changing and displaying the length, type, and arrangement order of the plurality of sessions according to the user's operation.

The session block screen display step further includes a step, when the user clicks a random mix icon, which selects audio blocks randomly from among the audio blocks displayed on the audio mixing screen to create a selection block, and then displays the selection block in a different shade from the audio blocks.

A device for providing an audio mixing interface using multiple audio stems according to embodiment may comprise an audio mixing screen generation module displaying an audio mixing screen including an audio block screen which includes an audio block that corresponds to at least one stem item preset for at least one audio version pre-stored for the audio on a display of a user device when audio to be mixed is executed by the user, and when a selection block selected by the user exists among the audio blocks displayed on the audio mixing screen, indicating the selection block shaded in a different shade from the audio blocks, and a mixing audio generation module, when the user's selection of the audio block is completed, combining the audio information included in the selection block and generating one session audio.

A server for providing an audio mixing interface using multiple audio stems according to embodiment may comprise an audio mixing screen generation module displaying an audio mixing screen including an audio block screen which includes an audio block that corresponds to at least one stem item preset for at least one audio version pre-stored for the audio on a display of a user device when audio to be mixed is executed by the user, and when a selection block selected by the user exists among the audio blocks displayed on the audio mixing screen, indicating the selection block shaded in a different shade from the audio blocks, and a mixing audio generation module, when the user's selection of the audio block is completed, combining the audio information included in the selection block and generating one session audio.

### Advantageous Effects

A method and audio mixing interface providing device using a plurality of audio stems according to an embodiment allows users to actively mix and produce audio of their desired taste, so there are advantages thereby providing an audio streaming service more tailored to the user's taste.

A method and audio mixing interface providing device using a plurality of audio stems according to an embodiment can analyze stems of audio currently being played and naturally add audio containing stems with similar characteristics to a play list.

Accordingly, the present invention has the advantage of providing a variety of audio streaming services more suited to the user's taste.

### BRIEF DESCRIPTION OF DRAWINGS

FIG. 1 is a diagram showing a partial configuration of a system for providing an audio mixing interface using a plurality of audio stems according to an embodiment of the present invention.

FIG. 2 is a diagram showing a partial configuration of an audio mixing interface providing device using a plurality of audio stems according to an embodiment of the present invention.

FIG. 3 is a diagram showing how to create a complete sound source by dividing it into several versions, and then create a pack in which several stem items for each version are divided into block format and combined.

FIG. 4 to 10 are diagrams showing various types of screens that can be displayed on a user device according to a method of providing an audio mixing interface according to an embodiment of the present invention.

FIG. 11 is a diagram illustrating two methods in which the play list generation module applies artificial intelligence technology to create a play list according to an embodiment of the present invention.

FIG. 12 is a diagram showing how various styles of audio are generated by an automatic mixing method using artificial intelligence technology according to an embodiment of the present invention.

FIG. 13 is a diagram illustrating an interface screen on which audio is played by applying artificial intelligence technology according to an embodiment of the present invention.

FIGS. 14 and 15 are diagrams showing a method of creating an artificial intelligence play list according to an embodiment of the present invention.

FIG. 16 is a diagram showing an actual audio mixing interface screen implemented by applying the present invention.

FIG. 17 is a diagram showing a mixing audio playback interface screen implemented by applying the present invention.

### MODES OF THE INVENTION

Hereinafter, embodiments according to the present invention will be described with reference to the accompanying drawings.

In adding reference numbers to each drawing, it should be noted that the same components have the same numerals as much as possible even if they are displayed on different drawings. In addition, in describing an embodiment of the present invention, if it is determined that a detailed description of a related known configuration or function hinders understanding of the embodiment of the present invention, the detailed description thereof will be omitted.

In addition, embodiments of the present invention will be described below, but the technical idea of the present invention is not limited or limited thereto and can be modified and implemented in various ways by those skilled in the art.

In addition, terms used in this specification are used to describe embodiments and are not intended to limit and/or limit the disclosed invention. Singular expressions include plural expressions unless the context clearly dictates otherwise.

In this specification, terms such as “include”, “include” or “have” are intended to designate that there is a feature, number, step, operation, component, part, or combination thereof described in the specification, but one or the existence or addition of more other features, numbers, steps, operations, components, parts, or combinations thereof is not excluded in advance.

In addition, throughout the specification, when a part is said to be “connected” to another part, this is not only the case where it is “directly connected”, but also the case where it is “indirectly connected” with another element in the middle. Terms including ordinal numbers, such as “first” and “second” used herein, may be used to describe various components, but the components are not limited by the terms.

Hereinafter, with reference to the accompanying drawings, embodiments of the present invention will be described in detail so that those skilled in the art can easily carry out the present invention. And to clearly explain the present invention in the drawings, parts irrelevant to the description are omitted.

Meanwhile, the title of the present invention is described as ‘a method and audio mixing interface providing device using a plurality of audio stems’, but for the convenience of the following, it will be explained that abbreviated as ‘a audio mixing interface providing device using a plurality of audio stems’ is referred to as ‘a audio mixing interface providing device’.

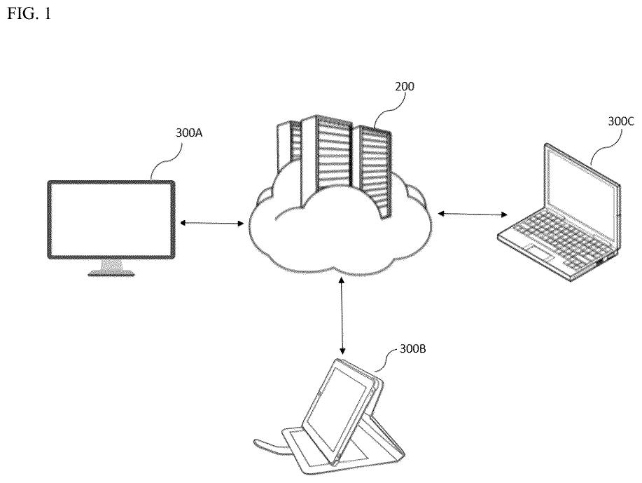

FIG. 1 is a diagram illustrating a partial configuration of a system for providing an audio mixing interface using a plurality of audio stems according to an embodiment.

Referring to FIG. 1, an audio mixing interface providing system according to an embodiment includes an audio mixing interface providing device 200 that provides an audio mixing interface to the user device 300, and a user device 300 that displays an audio mixing interface received from the audio mixing interface providing device 200 on a display.

The user device may include a plurality of user devices 300A, 300B, and 300C as shown in the figure.

The audio mixing interface providing device 200 can create an interface that allows the user to mix and edit audio stored in the user device 300 or an external server (not shown) linked to the user device 300 to the user's taste, and the created interface can be provided to the user through the user device 300. A detailed operational explanation for this will be provided later.

The audio mixing interface providing device 200 may be implemented as a server device to create an audio mixing interface and transmit the generated audio mixing interface to the user device 300.

The server in the present invention refers to a typical server.

A server is computer hardware on which a program is running, and monitors or controls the entire network, such as printer control or file management, or connects to other networks through a mainframe or public network, software resources such as data, programs, and files, or modems and faxes, printer sharing. It can support sharing hardware resources such as other equipment.

The user device 300 may display the audio mixing interface provided by the audio mixing interface providing device 200 on the display of the user device 300 using a specific program or application installed on the user device 300.

Meanwhile, in FIG. 1, the audio mixing interface providing device 200 is implemented as a server and is described on the basis that the user receives an interface for mixing and editing audio from the server. However, the embodiment of the present invention is not limited to the fact that the audio mixing interface providing device 200 according to the present invention is implemented as a server.

The audio mixing interface providing device 200 according to the present invention may be implemented as a user device 300.

When the audio mixing interface providing device 200 is implemented as the user device 300, the processor included in the user device 300 directly creates an audio mixing interface screen and displays the generated interface screen on the user device 300.

Specifically, the user device 300 includes a processor capable of generating an audio mixing interface screen.

The processor may generate an audio mixing interface screen and provide the generated screen to the user through the display of the user device 300.

Therefore, users can edit and manage the audio they want to mix to their taste through the audio mixing interface.

Accordingly, the user device 300 may be implemented with several terminal devices including processors so that these algorithms can be realized. For example, the user device may be implemented as a personal computer (PC) 300A, a smart pad (300B), or a notebook (notebook) (300C), as shown in FIG. 1.

In addition, although not shown in the drawing, the user device 300 includes a Personal Digital Assistant (PDA) terminal, a Wireless Broadband Internet (Wibro) terminal, a smartphone, a tablet PC, a smart watch, and smart glasses. It can be implemented with all types of handheld-based wireless communication devices, such as glass and wearable devices.

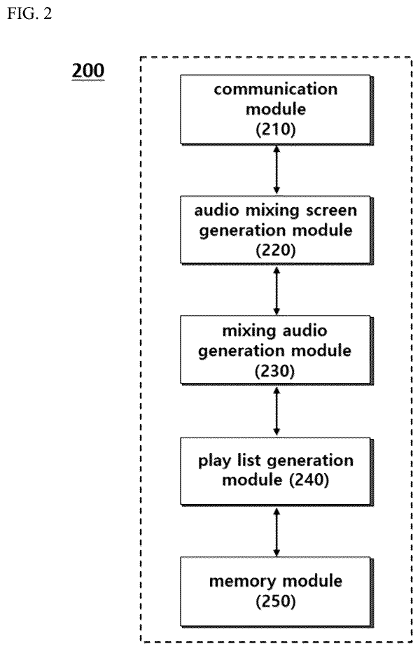

FIG. 2 is a diagram illustrating a partial configuration of an audio mixing interface providing device using a plurality of audio stems according to an embodiment.

Referring to FIG. 2, the audio mixing interface providing device 200 according to an embodiment includes a communication module 210, an audio mixing screen generation module 220, a mixing audio generation module 230, and a play list generation module 240. and a memory module 250.

Meanwhile, in FIG. 2, for convenience of explanation, the communication module 210, the audio mixing screen generation module 220, the mixing audio generation module 230, and the play list generation module 240 are shown separately, but the embodiment according to the present invention is not limited to this independent configuration.

Specifically, the communication module 210, the audio mixing screen generation module 220, the mixing screen generation module 230, and the play list generation module 240 can be configured and implemented one processing module that functions as a processor.

If the audio mixing interface providing device 200 is implemented as a server-like device, the communication module 210 can perform wireless communication with the user device 300 and an external server (not shown) storing audio data, etc.

The communication module 210 can send the audio mixing interface generated by the audio mixing screen generation module 220 and the mixing audio generation module 230 based on audio data received from at least one of the user device 300 to an external server to the user device 300.

In another embodiment of the present invention, when the audio mixing interface providing device 200 is implemented as the user device 300, the communication module 210 of the audio mixing interface providing device 200 may receive audio data pre-stored by a user at an external server or audio data pre-stored by a company operating an external server, and the received audio data may be stored in the memory module 250.

The audio mixing screen generation module 220 can generate various screens (panels) displayed on the display of the user device 300 and display the generated screens on the display of the user device 300.

In the present invention, a panel refers to a portion of an interface divided according to the nature of the content displayed on the display screen.

Accordingly, a plurality of panels can be created depending on the nature of the content, and the plurality of generated panels can be displayed simultaneously on the display screen.

Additionally, the size of the panel can be automatically adjusted according to the number of panels created and can be made smaller or larger depending on the user's manipulation.

The audio mixing screen generation module 220 according to the present invention can generate screens with different characteristics and display the generated screens on the display of the user device 300.

Specifically, when audio to be mixed is executed by the user, the audio mixing screen generation module 220 loads at least one audio version pre-stored for the executed audio, and at least one preset version for each loaded audio version. An audio block corresponding to one or more stem items can be created, and an audio block screen including the generated audio block can be displayed on the display of the user device.

Audio here refers to music data that includes all the songs and accompaniments that we commonly listen to, and the stem classifies each audio track that makes up one piece of music, considering the sound range and function.

Specifically, the sound source that makes up the audio is composed of human vocals and the sounds of various instruments combined to form a single result, and the stem here refers to data about a single item that makes up the sound source.

For example, types of stems may include rhythm stems, bass stems, mid stems, high stems, FX stems, and melody stems.

Additionally, if a selection block selected by the user exists among the audio blocks displayed on the audio mixing screen, the audio mixing screen generation module 220 may display the selection block in a different shade from the audio blocks.

Additionally, the audio mixing screen generation module 220 may generate audio information corresponding to the selected block as waveform information and then display the generated waveform information on the audio mixing screen.

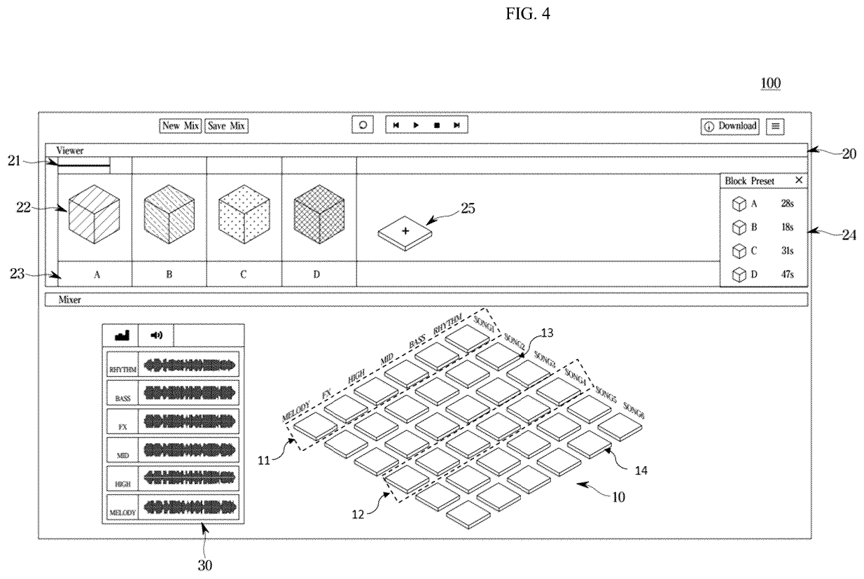

A detailed description of this will be provided through FIGS. 4 to 8.

When the user's audio mixing is completed (i.e., when the user's audio block selection is completed), the mixing audio generation module 230 can combine the audio information included in the selection block to generate one session audio.

A session as used in the present invention refers to one part divided into a certain time unit for one audio.

The standard for dividing a session can be equal time units, but considering the overall flow of audio, it can also be divided based on sections where the characteristics of the audio change.

The criteria for dividing sessions in this way are set and stored in advance by the music producer or can be freely changed by user manipulation. Additionally, reverberation may be placed between sessions set in this way so that the connection of music between sessions becomes natural.

In addition, the mixing audio generation module 230 can integrate the plurality of sessions created in this way to create one mixing audio, and data related to the mixed audio or session audio created in this way can be stored in the memory module 250.

The play list generation module 240 may create a list of audios mixed by the user and then play the audio existing in the list.

The play list created by the play list generation module 240 may include audio mixed by the user but may also include mixed audio created by randomly mixing the play list generation module 240 by applying artificial intelligence technology.

When the play list generation module 240 creates a play list by applying artificial intelligence technology, the name of the play list generation module 240 reflects its characteristics and could be referred as an artificial intelligence-based automatic mixing module, AI automatic mixing module, etc.

Specifically, the play list generation module 240 may include audio similar to the audio mixed by the user in the play list and may search for audio that is similar to only a specific stem in the audio mixed by the user and include it in the play list.

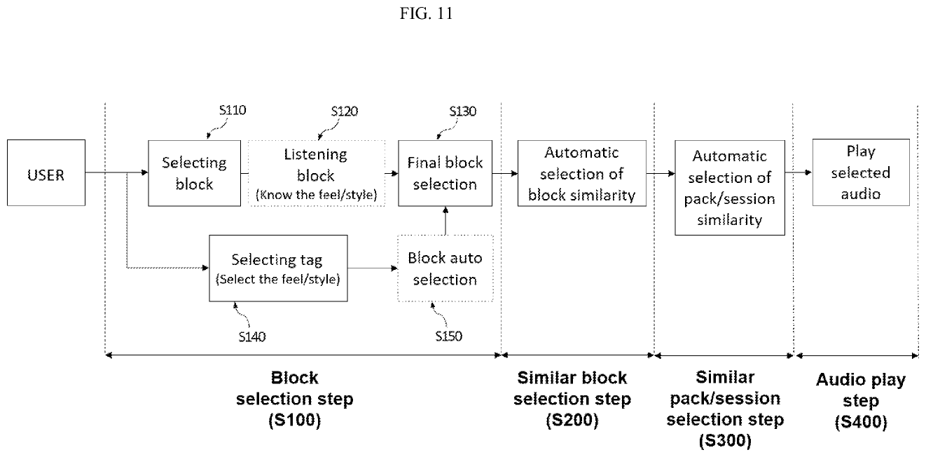

Additionally, the play list generation module 240 may randomly remix the audio mixed by the user and include the generated audio in the play list. A detailed description of this will be provided through FIGS. 11 to 14.

The memory module 250 refers to a module in which data related to audio previously saved by the user and mixed audio can be stored.

When the audio mixing interface providing device 200 is implemented as the user device 300, the memory module 250 is not included in the user device 300, and various data that can be stored in the memory module 250 are stored on the external server.

Therefore, in this case, the user device 300 can use the communication module 210 to receive data about various types of audios to be displayed on the audio mixing interface from an external server.

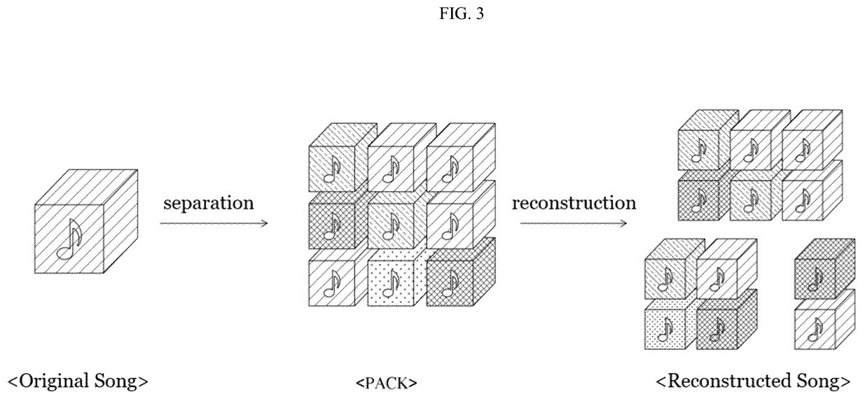

FIG. 3 is a diagram for explaining the overall operating concept of the audio mixing interface providing device according to the present invention.

To date, in the case of existing Web 2.0-based major audio streaming services, only services that play a single sound source that has already been completed are generally provided, which has the disadvantage of not meeting the individual needs for audio that each user has.

In other words, even if it is the same song, there is a desire to listen to the converted audio with different feelings depending on the user, but the conventional audio streaming service has the disadvantage of not being able to provide various versions of the sound source service because it unilaterally provides only the completed sound source.

Therefore, the purpose of the present invention is to provide a flexible, adaptive audio listening service optimized for the user's needs and at the same time provide a Web 3.0-based audio streaming service that can be combined with multiple audios.

Specifically, as shown in FIG. 3, the present invention creates a complete sound source by dividing it into several versions, and then creates a pack in which several stem items for each version are divided into block format and combined. There is a feature that the user can create new sound source data by recombining blocks to suit his or her taste.

The pack described in the present invention refers to data in the form of a collection of several stem data constituting each audio for several versions of audio generated for one audio. This part will be explained in detail with reference to FIG. 4.

Meanwhile, a completed sound source within the meaning of the present invention may be audio produced in block format from the beginning or may be audio that has already been released but produced in block format with the consent of the composer.

The features of the audio mixing interface providing device will be examined in detail through the drawings below.

FIGS. 4 to 10 are diagrams showing various types of screens that can be displayed on a user device according to the method of providing an audio mixing interface according to the present invention.

Referring FIGS. 4 to 10, the audio mixing screen 100 may include an audio block screen 10, a session block screen 20, and a waveform information screen 30.

The audio block screen 10 is a screen that displays pack data for the executed audio described in FIG. 3.

Specifically, as shown in FIG. 3, when audio to be mixed by a user selected by the user is executed, the audio block screen 10 aligned and displays audio blocks corresponding to at least one preset stem item (Rhythm, Bass, Mid, High, FX, and Melody in the drawing) about at least one audio version (SONG1 to SONG6 in the figure) pre-stored for the executed audio.

In the drawing, the audio information corresponding to the stem items of various versions of the executed audio is abstracted and displayed as an icon called a block, but the expression method of the present invention is not limited to blocks and it can be expressed with various types of icons.

In general, as described above, audio refers to audio that is a combination of audio from a plurality of stems, so when the audio versions are different, the audio according to the stems also has different characteristics.

Accordingly, reference numeral 11 in the drawing means that information about a plurality of stems included in the first version of the executed audio is expressed as audio blocks.

Additionally, reference numeral 12 indicates that information about a plurality of stems of the fourth version of the executed audio is expressed as audio blocks.

Therefore, when the user clicks on a specific audio block, the corresponding audio may be output.

For example, when the user clicks on the audio block 13 corresponding to the BASS of the second version (SONG 1), audio with only the bass extracted based on the second version of the executed audio is output.

Additionally, when the user clicks on the audio block 14 corresponding to the base (MELODY) of the 6th version (SONG 2), audio in which only the melody is extracted based on the 6th version of the executed audio may be output.

Meanwhile, in the drawing, six versions of the executed audio are shown, but this is only an example.

Accordingly, the number of audio versions displayed on the audio block screen 10 may vary depending on the characteristics of the audio executed by the user.

The types of stems displayed on the audio block screen 10 may also be displayed in numbers different from those shown in the drawing.

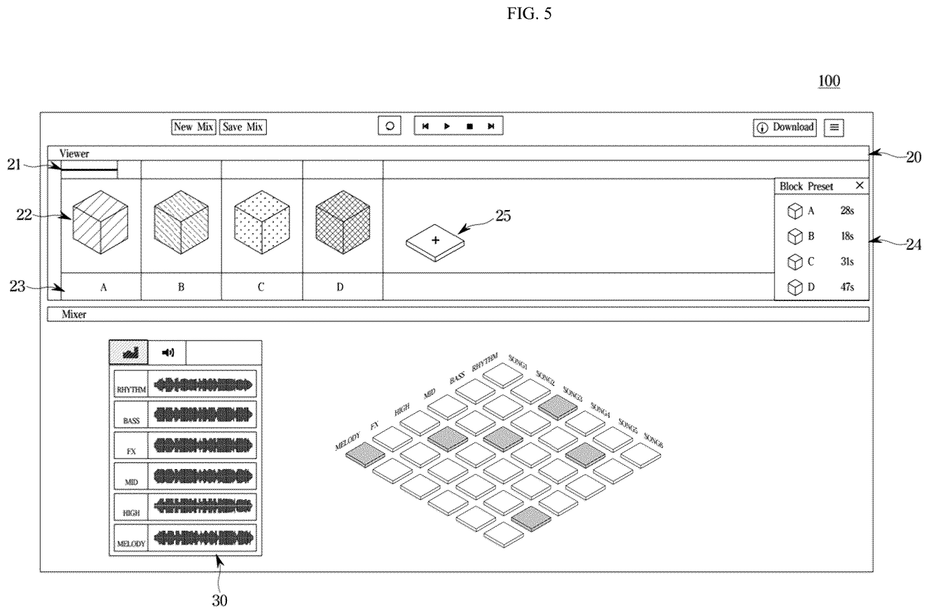

Additionally, when the user clicks on specific audio blocks as shown in FIG. 5, the clicked audio blocks may be shaded to distinguish them from other non-clicked audio blocks.

Additionally, the audio characteristics of the clicked audio block may be displayed on the audio mixing screen 100.

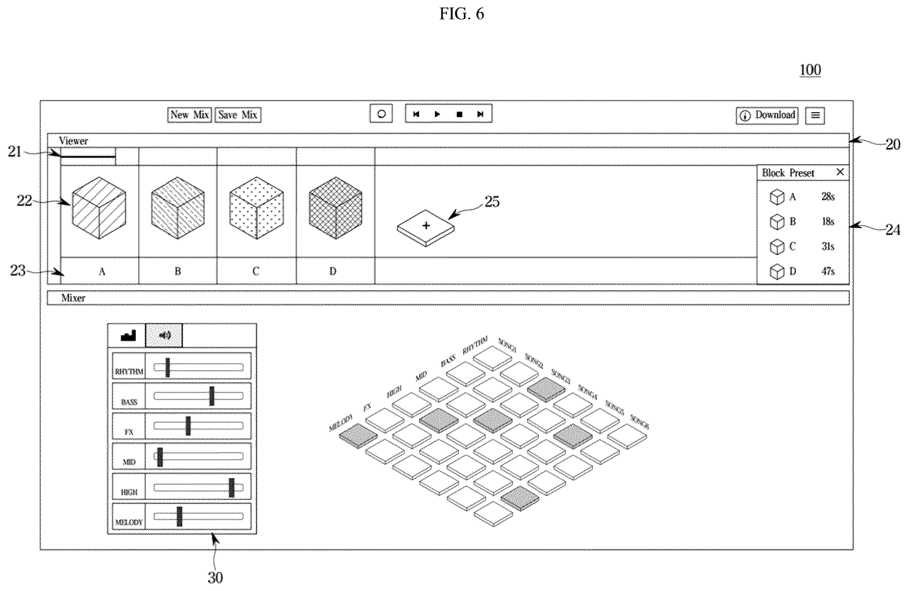

Specifically, as shown in the lower left of FIGS. 5 and 6, a waveform information screen 30 or a volume information screen 30 of blocks included in the selected blocks may be visually generated and displayed on the screen.

Therefore, the user can intuitively know the information about the audio waveform and volume information of the currently clicked audio block, enabling audio mixing more tailored to the user's preference.

Meanwhile, since audio generally proceeds in chronological order, it can be divided into several sections according to the characteristics of each section.

In the present invention, this section is defined as a session, and the session block screen 20, which contains information about the sessions divided into a plurality of sessions, is displayed at the top of the audio mixing screen 100 as shown in the drawing.

For example, if one audio is divided into four sessions, the session section names may be divided into four sections A, B, C, and D as shown in the drawing (refer to reference numeral 23).

Since each session has different characteristics due to the nature of audio, it can be displayed as four rectangular parallelepipeds with different patterns as shown in the drawing (see reference numeral 22).

Meanwhile, although not shown in the drawing, a specific session of audio that the user is currently mixing may be shaded at reference numeral 23.

If audio is currently playing, a play bar 21 may be displayed as shown in the drawing.

Accordingly, an advantage of the present invention exists because the user can intuitively know which part of the entire audio session is being mixed through this interface.

Additionally, the user can add a new session by clicking the Add Session Block 25 icon displayed on the session block screen 20.

Meanwhile, when the user clicks the Add Session Block 25 icon, a session information screen 24 in which session information is summarized and displayed may be displayed.

The session information screen 24 may display the type of session currently being played and play time information indicating the play time of each session.

Meanwhile, the audio being executed may be audio that has only some of the six stems shown in the drawing, depending on the characteristics of the version.

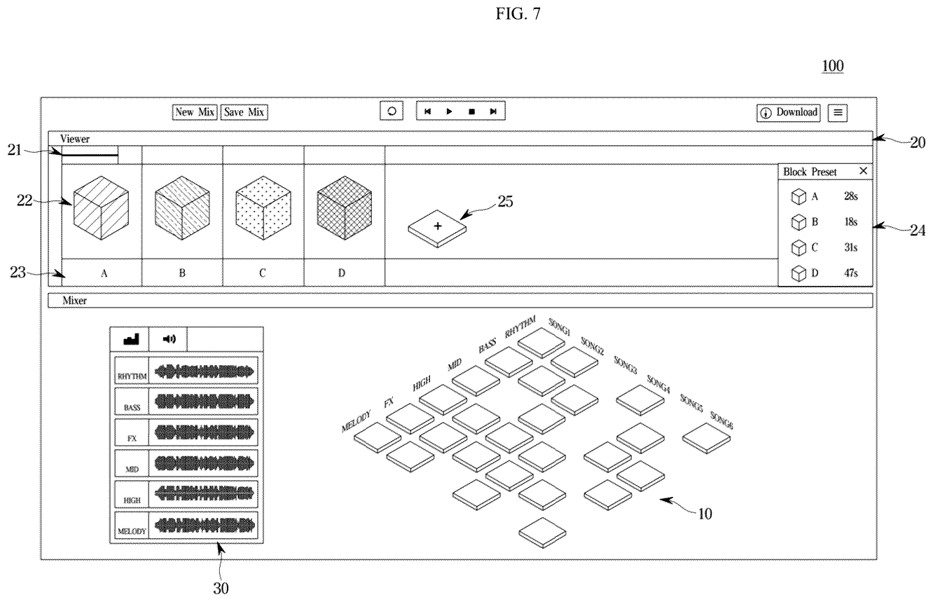

Accordingly, if the user executes a specific audio, and several versions of the executed audio do not have information about specific stems, only the audio block corresponding to the stem contained in the corresponding version can be expressed, as shown in FIG. 7.

Therefore, the user has the advantage of being able to intuitively know the stem information of various versions of the executed audio immediately.

The user can mix audio according to his or her taste using the audio block screen 10, session block screen 20, and waveform information screen 30 described so far.

In other words, the user can create mixed audio by clicking to turn on/off various audio blocks and turning on only the audio blocks that suit the user.

Mixed audio can be created as session audio mixed only for a specific session from the entire audio, or as mixed audio mixed for the entire audio session.

Meanwhile, the user can access the session block screen 20 and use the interface to change the session playback time, type, and arrangement order.

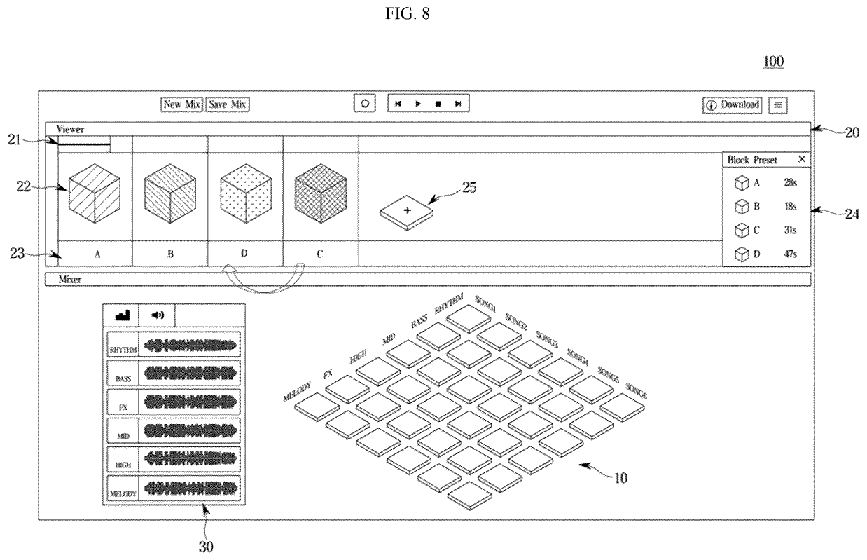

As an example, as shown in FIG. 8, the user clicks on the section name of the session displayed on the session block screen 20 (see reference numeral 23, A, B, C, and D in FIG. 7) and moves it to the desired location. Alternatively, user can change the playback order of sessions by clicking on the cuboid that displays the session properties and then moving to the desired session location.

Comparing FIGS. 5 and 8, it can be seen in FIG. 8 that the user changed the order of sessions C and D.

Additionally, users can upload their own custom audio and then mix the uploaded audio. For example, users can record the user's voice or instrument and then upload it.

Additionally, the user can directly select blocks and listen to music based on the selected blocks but can also listen to audio generated based on blocks randomly selected by the audio mixing interface providing device 100.

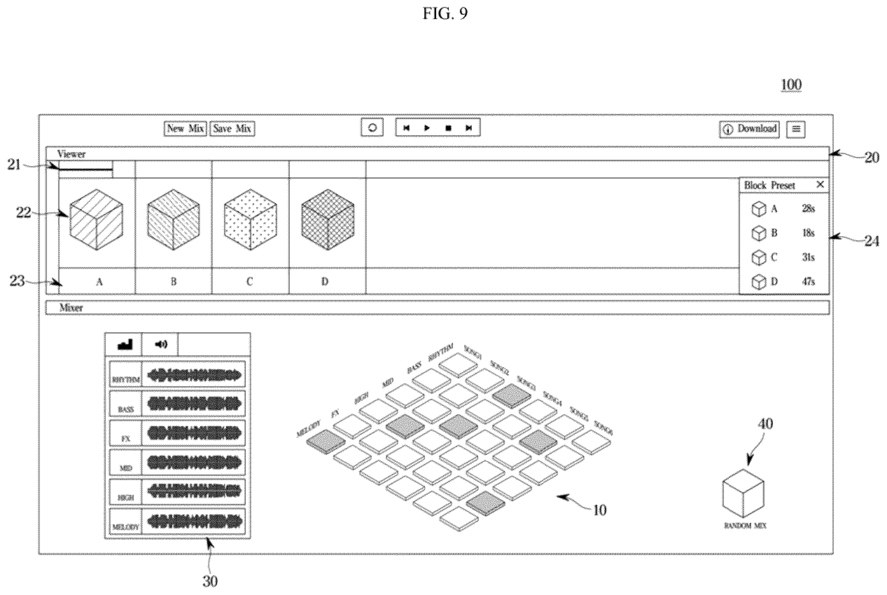

Specifically, as shown in FIG. 9, when the user clicks the random mixing icon 40, blocks are randomly selected on the audio block screen 10, and audio generated based on the randomly selected blocks can be output.

That is, whether the block is selected by the user or randomly, when the selection of blocks is finally completed, audio is generated based on the selected blocks.

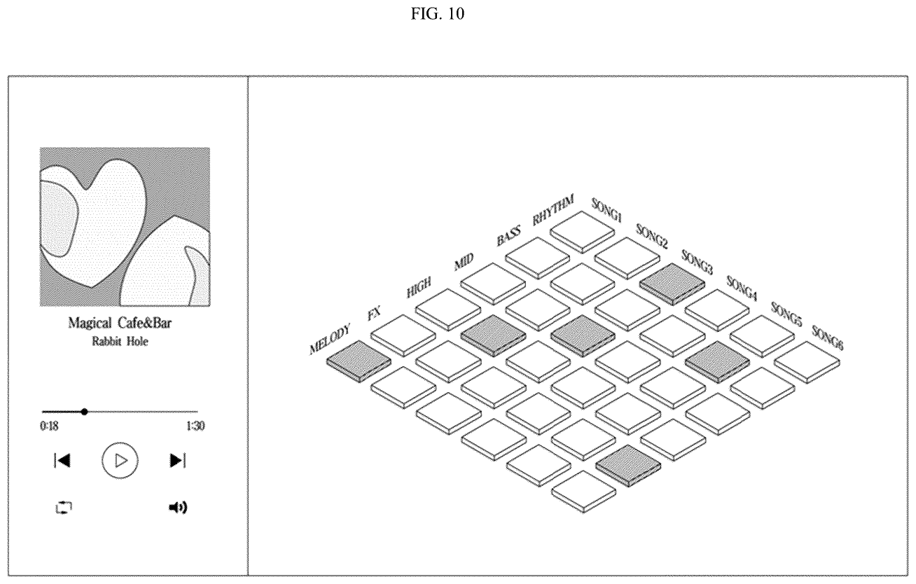

The audio generated in this way can be played through an interface as shown in FIG. 10.

The left screen in FIG. 10 is a screen that displays time information about the currently playing mixed audio.

In FIG. 10, since the audio block screen in the 18-second section is displayed, if the 1 minute and 10-second section is a section that is a different session from the current 18-second section, the selected audio blocks displayed on the audio block screen are displayed differently with those shown in FIG. 10.

Accordingly, the user can intuitively know which part of the entire audio is currently being played and which audio blocks are combined with that part.

Meanwhile, audio files that have been mixed by the user can be issued as a Non-Fungible Token (NFT) and then provided to a company that provides an audio streaming service and used for streaming services.

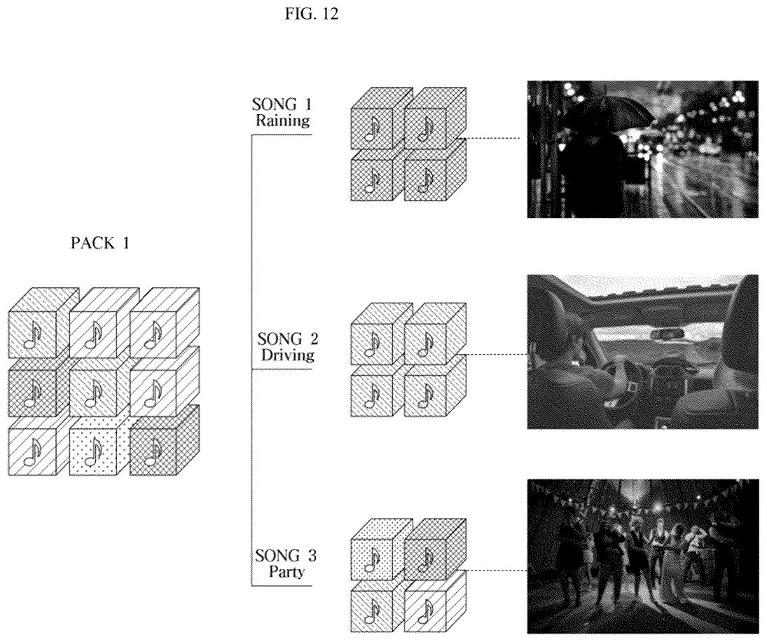

FIG. 11 is a diagram showing two methods in which the play list generation module generates a play list by applying artificial intelligence technology according to an embodiment of the present invention, and FIG. 12 is a diagram showing two methods of creating a play list by applying artificial intelligence technology according to an embodiment of the present invention. This diagram shows how various styles of audio are generated by this applied automatic mixing method.

Referring to FIG. 11, the play list generation module 240 according to the present invention can create a play list by selecting similar blocks and packs/sessions based on the finally selected final block.

At this time, there are two ways in which the final block is created: a method selected by the user and a method selected automatically by applying artificial intelligence technology.

Specifically, the method by which the final block is selected by the user is the method according to S110, S120, and S130 of FIG. 11.

Specifically, after the user directly selects a block (S110), and after the user listens to the audio according to the selected block to determine the feeling or style of the audio being played (S120), the blocks directly selected by the user are selected and converted into the final blocks (S130).

Specifically, when the user selects specific blocks based on the method described in FIGS. 4 to 9, the user listens to the audio based on the selected block and then decides whether to reselect the block or select the currently selected block as the final block.

Additionally, when the blocks are finally selected by this method, the play list generation module 240 ends the block selection step (S100) and proceeds to the next step, the block similarity selection step (S200).

Conversely, if the user selects the automatic mixing method using artificial intelligence technology, the playlist generation module 240 receives tag information containing audio feel or style information from the user and the final block can be selected automatically as a basis on received tag information.

As an example, as shown in FIG. 12, if the user selects a rainy atmosphere as a tag in a situation where it is currently raining, the playlist generation module 240 creates the final block so that audio in a style that matches the rainy atmosphere can be output.

Additionally, if tag information about the drive is received from the user, the play list generation module 240 can select the final block so that audio in a style that matches the drive atmosphere can be output.

Additionally, when tag information related to the party is received from the user, the play list generation module 240 may select the final block so that audio in a style that matches the party atmosphere can be output.

Additionally, the play list generation module 240 may generate a play list based on the final block selected.

Meanwhile, in FIG. 12, it is explained that the user directly provides tag information to the audio mixing interface providing device 200.

However, in contrast, the audio mixing interface providing device 200 generates tag information appropriate for the current situation based on the current user's location information, user's schedule information, user's personal information, and weather information, and then tags the generated tag information. Based on this, the final block may be automatically selected.

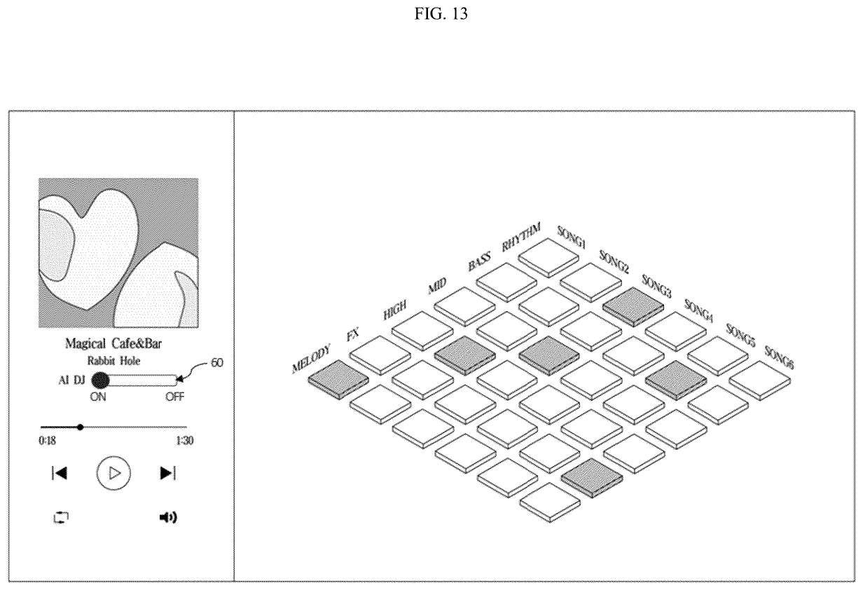

In addition, in one embodiment, after the user selects specific blocks and activates the AI DJ bar 60 to ON as shown in FIG. 13, the play list generation module 240 creates a similar block based on the blocks selected by the user and it create a playlist of audio that has a similar feeling.

When creating a play list, the play list generation module 240 may select similar blocks and similar packs/sessions based on the selected blocks (S200 and S300) and create a play list based on these.

Let's learn more about how to create a play list through the drawing below.

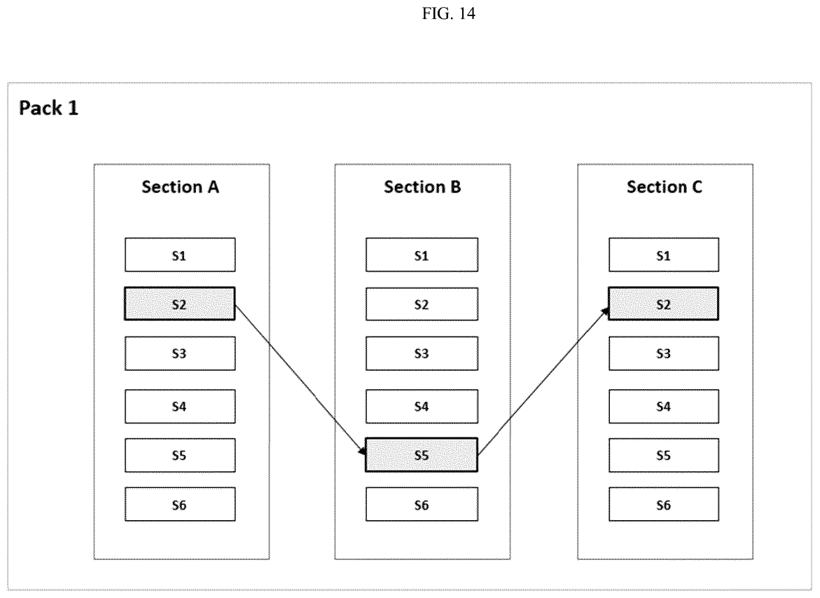

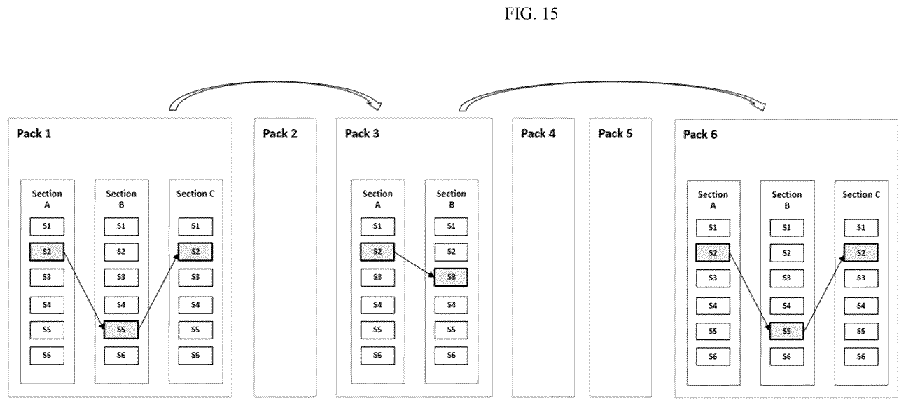

FIGS. 14 and 15 are diagrams showing a method of generating an artificial intelligence play list according to an embodiment of the present invention. Specifically, FIG. 14 is a diagram showing a method of generating an artificial intelligence play list based on a stem. 15 is a diagram showing a method of creating an artificial intelligence play list based on a pack.

The play list generation module 240 can create an artificial intelligence play list.

When an artificial intelligence playlist is created in this way, there is an advantage in that the audio can be continuously reorganized into a different version without interruption or can continue to be played naturally as a different song.

Specifically, the play list generation module 240 may utilize audio feature extraction and auto tagging technology.

The playlist generation module 240 uses stem and feature analysis technology of the currently playing audio to analyze the stem or pack in detail, selects the next stem or pack to be played, and performs the next playlist based on the selected stem or pack and it can select the audio to be played next.

Meanwhile, the playlist generation module 240 can apply various DJing techniques (Fader, EQ, reverb, echo), etc. when creating a playlist so that songs can be naturally connected at the connection between songs.

Referring to FIG. 14, when explaining the method of creating a play list based on a stem, if session A of PACK 1 is currently being played, the play list generation module 240 selects one stem among several stems of session A according to a preset standard.

Here, the preset standard can be determined by several criteria. For example, it may be the stem that shows the greatest characteristics in the audio being played, or it may be the stem that the user is most interested in among several stems.

In addition, the preset standard may be a randomly selected stem, and a method of selecting similar stems is to apply artificial intelligence technology to generate an embedding vector for each stem, and then select similar stems based on the generated embedding vector.

For example, if the play list generation module 240 selects the second stem S2, the play list generation module 240 selects a stem in session B that has similar characteristics to the second stem S2 of session A.

As shown in the figure, if the 5th stem S5 is selected in the second session, the play list generation module 240 continues to compare and analyze the stems of session C based on the 5th stem S5 to select the 5th stem S5 for the next session.

If the play list generation module 240 are comparing and analyzing stems, if a stem does not have a specific audio block selected, it may not continue to be selected.

Additionally, when creating a play list, selection may be made somewhat randomly to avoid monotony in the audio composition that may result from repetitive stem selection.

Referring to FIG. 15, a method for creating a play list based on a PACK will be described.

Assuming that PACK 1 is currently being played, the play list generation module 240 selects a pack that has characteristics similar to the audio currently being played in PACK 1, and within the selected pack, a pack that has characteristics similar to the audio currently being played in PACK 1.

For example, as shown in the figure, PACK 3, not PACK 2, which is the next pack of PACK 1, may be selected as a pack like PACK 1, and PACK 6 may be created as the next pack of PACK 3.

Meanwhile, the criteria for selecting similar packs can be selected by applying artificial intelligence technology.

For example, the playlist generation module 240 may calculate the average embedding of all blocks of sessions of the currently playing pack and then select a similar pack by comparing the average embedding with the average embedding of other packs based on the calculated average embedding.

Once a pack is selected, blocks within the pack can be automatically selected based on the selected information in step S200.

When a pack is switched, it may start from the first session of the next connected pack after all currently playing packs have ended but may also start from the middle session of the next connected pack.

Meanwhile, the pack transition does not always continue after all playback is completed, but the packs can be connected in such a way that the climax part of the currently playing pack is heightened and then directly connected to the climax part of the next pack to be played.

Meanwhile, when packs are switched, various DJing techniques (Fader, EQ, reverb, echo), etc. can be applied to ensure a natural connection in the transition between packs.

In the case of the present invention, it is possible to provide the user with several randomly mixed versions of audio without the user having to mix the audio directly, so there is an advantage that the user can more easily listen to the audio of the style he or she wants.

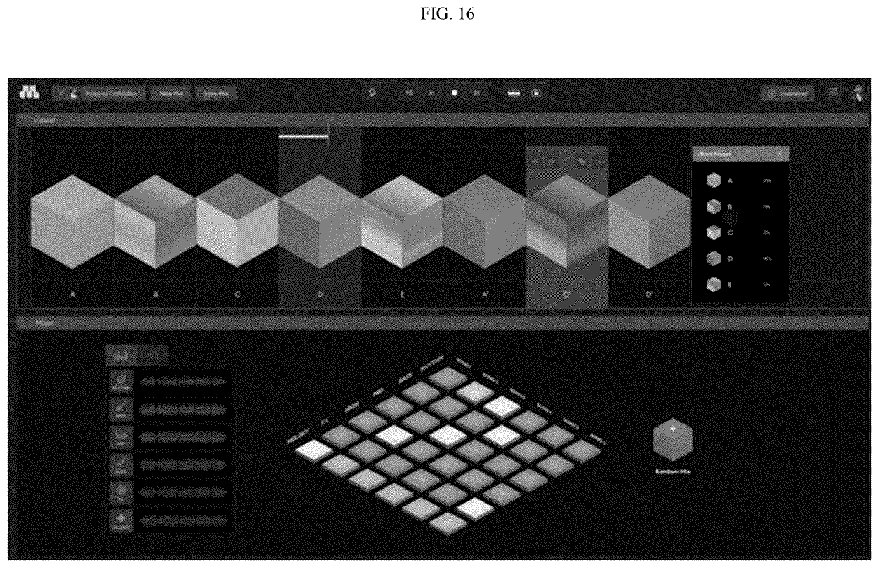

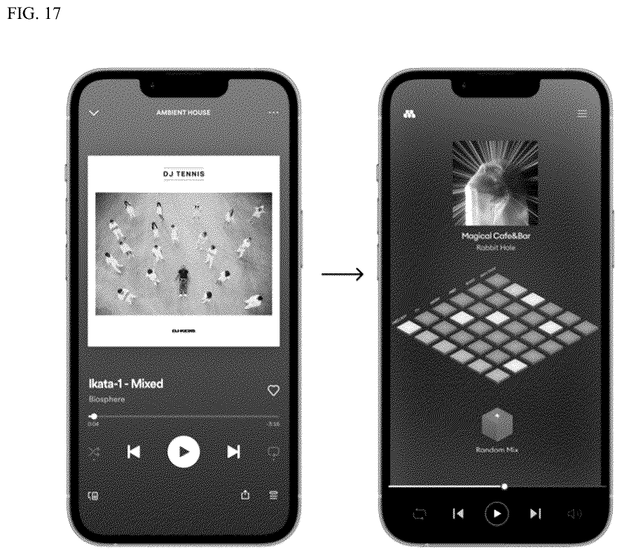

FIG. 16 is a diagram showing an actual audio mixing interface screen implemented by applying the present invention, and FIG. 17 is a diagram showing a mixing audio playback interface screen implemented by applying the present invention.

Referring to FIG. 16, when mixed audio is played by a streaming service, only a cover image of the corresponding audio may be displayed on the interface screen, as shown in the left screen of FIG. 16.

In this state, when the user clicks on the audio cover, an audio block screen containing audio block information for the current section of the audio being played may be displayed on the interface screen as shown in the right screen of FIG. 16.

Through this, the user has the advantage of being able to intuitively know the block information of the currently playing audio at once.

So far, we have looked in detail at the method and audio mixing interface providing device using a plurality of audio stems according to the present invention.

A method and audio mixing interface providing device using a plurality of audio stems according to an embodiment allows users to actively mix and produce audio of their desired taste, so there are advantages thereby providing an audio streaming service more tailored to the user's taste.

A method and audio mixing interface providing device using a plurality of audio stems according to an embodiment can analyze stems of audio currently being played and naturally add audio containing stems with similar characteristics to a play list.

Accordingly, the present invention has the advantage of providing a variety of audio streaming services more suited to the user's taste.

The devices described above may be implemented as hardware components, software components, and/or a combination of hardware components and software components.

For example, devices and components described in the embodiments may include, for example, a processor, a controller, an arithmetic logic unit (ALU), a digital signal processor, a microcomputer, a field programmable array (FPA), It may be implemented using one or more general purpose or special purpose computers, such as a programmable logic unit (PLU), microprocessor, or any other device capable of executing and responding to instructions.

The processing device may run an operating system (OS) and one or more software applications running on the operating system.

The method according to the embodiment may be implemented in the form of program instructions that can be executed through various computer means and recorded on a computer readable medium.

The computer readable medium may include program instructions, data files, data structures, etc. alone or in combination. Program commands recorded on the medium may be specially designed and configured for the embodiment or may be known and usable to those skilled in computer software.

Examples of computer-readable recording media include magnetic media such as hard disks, floppy disks and magnetic tapes, optical media such as CD-ROMs and DVDs, and magnetic media such as floptical disks.—includes hardware devices specially configured to store and execute program instructions, such as magneto-optical media, and ROM, RAM, flash memory, and the like.

Examples of program instructions include high-level language codes that can be executed by a computer using an interpreter, as well as machine language codes such as those produced by a compiler.

As described above, although the embodiments have been described with limited examples and drawings, those skilled in the art can make various modifications and variations from the above description. For example, the described techniques may be performed in an order different from the method described, and/or components of the described system, structure, device, circuit, etc. may be combined or combined in a different form than the method described, or other components may be used. Or even if it is replaced or substituted by equivalents, appropriate results can be achieved.

Therefore, other implementations, other embodiments, and equivalents of the claims are within the scope of the following claims.

1. A method of providing an audio mixing interface using multiple audio stems comprising:
an audio mixing screen display step which displays an audio mixing screen including an audio block screen indicating audio blocks corresponding to at least one stem item preset for at least one audio version pre-stored for the audio on the display of a user device by a processor, when audio to be mixed is executed by the user;
an audio block selection step which displays a selection block on a display of the user device in a shade different from that of the audio blocks by the processor, when the selection block selected by the user exists among the audio blocks displayed on the audio mixing screen; and
an audio session generation step which combines the audio information included in the selection block and create one session audio, when the user's selection of the audio block is completed.

2. The method of providing the audio mixing interface using multiple audio stems according to claim 1,
wherein the stem item includes at least one of the audio's Rhythm stem, Bass stem, Mid stem, High stem, FX stem, and Melody stem.

3. The method of providing the audio mixing interface using multiple audio stems according to claim 1,
wherein the audio mixing screen display step further comprises a step, if there is a selection block selected by the user among the audio blocks, generating audio information corresponding to the selection block as waveform information and then displaying the waveform information on the audio mixing screen.

4. The method of providing the audio mixing interface using multiple audio stems according to claim 1,
wherein the audio mixing screen display step further includes a session block screen display step which divides the audio into a plurality of sessions over time according to a preset standard and then displays a session block screen including a plurality of session blocks corresponding to the plurality of sessions on the audio mixing screen.

5. The method of providing the audio mixing interface using multiple audio stems according to claim 4, further comprising:
a mixing screen change step, when the user selects a session block other than the currently selected session block among the plurality of session blocks, which newly displays an audio block screen corresponding to the other selected session block on the audio mixing screen.

6. The method of providing the audio mixing interface using multiple audio stems according to claim 4,
wherein the session block screen display step further includes a step changing and displaying the length, type, and arrangement order of the plurality of sessions according to the user's operation.

7. The method of providing the audio mixing interface using multiple audio stems according to claim 4,
wherein the session block screen display step further includes a step, when the user clicks a random mix icon, which selects audio blocks randomly from among the audio blocks displayed on the audio mixing screen to create a selection block, and then displays the selection block in a different shade from the audio blocks.

8. A device for providing an audio mixing interface using multiple audio stems comprising:
an audio mixing screen generation module displaying an audio mixing screen including an audio block screen which includes an audio block that corresponds to at least one stem item preset for at least one audio version pre-stored for the audio on a display of a user device when audio to be mixed is executed by the user, and when a selection block selected by the user exists among the audio blocks displayed on the audio mixing screen, indicating the selection block shaded in a different shade from the audio blocks; and
a mixing audio generation module, when the user's selection of the audio block is completed, combining the audio information included in the selection block and generating one session audio.

9. A server for providing an audio mixing interface using multiple audio stems comprising:
an audio mixing screen generation module displaying an audio mixing screen including an audio block screen which includes an audio block that corresponds to at least one stem item preset for at least one audio version pre-stored for the audio on a display of a user device when audio to be mixed is executed by the user, and when a selection block selected by the user exists among the audio blocks displayed on the audio mixing screen, indicating the selection block shaded in a different shade from the audio blocks; and
a mixing audio generation module, when the user's selection of the audio block is completed, combining the audio information included in the selection block and generating one session audio.
